(19) United States
(12) Patent Application Publication
(10) Pub. No.: US 2006/0114262 A1
(43) Pub. Date: Jun. 1, 2006

(54) Texture mapping apparatus, method and program

(76) Inventors: Yasunobu Yamauchi, Kawasaki-shi (JP); Shingo Yanagawa, Kawasaki-shi (JP); Masahiro Sekine, Yokohama-shi (JP); Yoshiyuki Kokojima, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/272,815

(22) Filed: Nov. 15, 2005

(30) Foreign Application Priority Data
Nov. 16, 2004 (JP) 2004-331943

(51) Int. Cl. G09G 5/00

(52) U.S. Cl. 345/582

(57) ABSTRACT

A texture mapping apparatus includes a vector computation unit configured to compute a plurality of projective coordinate system vectors to be acquired when a texture corresponding to an area included in a model surface is projected onto the area, based on configuration information of the area and the texture, a direction computation unit configured to compute an eyepoint direction from the area to an eyepoint and an illuminant direction from the area to an illuminant, based on the projective coordinate system vectors and a normal of a model plane of the area, and a changing unit configured to change the texture based on the eyepoint direction and the illuminant direction, and map the changed texture onto the model plane of the area.

### CROSS-REFERENCE TO RELATED APPLICATIONS

This application is based upon and claims the benefit of priority from prior Japanese Patent Application No. 2004-331943, filed Nov. 16, 2004, the entire contents of which are incorporated herein by reference.

### BACKGROUND OF THE INVENTION

1. Field of the Invention

The present invention relates to a texture mapping apparatus, method and program for performing high-quality texture mapping in the field of three-dimensional computer graphics. More particularly, it relates to a texture mapping apparatus, method and program for performing mapping and model data conversion to appropriately represent, without depending upon the texture coordinates assignment method, the optical characteristics of a substance surface that vary in accordance with the direction of an eyepoint and the direction of an illuminant.

2. Description of the Related Art

To represent the optical characteristics of a substance surface, a method is disclosed which utilizes a bi-directional texture function (BTF) that represents the texture components of a polygon surface in accordance with the direction of an eyepoint and the direction of an illuminant (see, for example, Dana, et al., “Reflectance and Texture of Real World Surfaces”, ACM Transaction on Graphics, 18(1):1-34, 1999). In general, in BTF data, image sampling is performed while varying two or three of the four variables that represent the direction of an eyepoint and the direction of an illuminant (see, for example, Chen, et al., “Light Field Mapping Efficient Representation and Hardware Rendering of Surface Light Fields”, Proceedings SIGGRAPH 2002, pp. 447-456).

However, in the above texture mapping method, a single or a plurality of texture images are attached based on the relative directions of the eyepoint and illuminant that are determined only based on the three-dimensional normal vectors of polygon surfaces and regardless of the method for assigning texture coordinates to polygons. Accordingly, if the texture coordinate assignment method causes distortion at a vertex of a polygon (e.g., if a deformation, such as expansion/contraction or shearing, occurs in a model space), an anisotropic appearance unique to the material of the texture substance cannot be represented.

Further, in the prior art, scalar values, such as position coordinates, texture coordinates, and color information, are set as vector attributes of vertices that define polygons as drawing units, there is no deficiency in drawing processing performed. However, since different texture projective coordinate systems (which define assignment of textures to a model) are employed on adjacent polygons, seams in textures may well occur at the boundaries of the polygons.

As described above, texture mapping employed in the prior art utilize the relative directions of the eyepoint and illuminant that are determined only based on the three-dimensional position and normal direction of the model and not on the assignment of texture coordinates. Therefore, the appearance unique to the texture material cannot appropriately be represented. Furthermore, if texture coordinates are determined on each polygon independently, seams in textures appear at the boundaries between neighboring polygons.

### BRIEF SUMMARY OF THE INVENTION

In accordance with a first aspect of the invention, there is provided a texture mapping apparatus comprising: a vector computation unit configured to compute a plurality of projective coordinate system vectors to be acquired when a texture corresponding to an area included in a model surface is projected onto the area, based on configuration information of the area and the texture; a direction computation unit configured to compute an eyepoint direction from the area to an eyepoint and an illuminant direction from the area to an illuminant, based on the projective coordinate system vectors and a normal of a model plane of the area; and a changing unit configured to change the texture based on the eyepoint direction and the illuminant direction, and map the changed texture onto the model plane of the area.

In accordance with a second aspect of the invention, there is provided a texture mapping apparatus comprising:

a model-data conversion apparatus including: a vector computation unit configured to compute a plurality of projective coordinate system vectors to be acquired when a texture corresponding to an area included in a model surface is projected onto the area, based on configuration information of the area and the texture; and a representative vector computation unit configured to compute a representative projective coordinate system vector which represents a plurality of areas included in the model surface, based on the projective coordinate system vectors, and

a texture drawing apparatus including: a direction computation unit configured to compute an eyepoint direction from the area to an eyepoint and an illuminant direction from the area to an illuminant, based on the representative projective coordinate system vector and a normal of a model plane of the area; a changing unit configured to change the texture based on the eyepoint direction and the illuminant direction, and map the changed texture onto the model plane.

In accordance with a third aspect of the invention, there is provided a texture mapping apparatus comprising:

a model-data conversion apparatus including: a vector computation unit configured to compute a plurality of projective coordinate system vectors to be acquired when a texture corresponding to an area included in a model surface is projected onto the area, based on configuration information of the area and the texture; a representative vector computation unit configured to compute a representative projective coordinate system vector which represents a plurality of areas included in the model surface, based on the projective coordinate system vectors; and a direction computation unit configured to compute an eyepoint direction from the area to an eyepoint and an illuminant direction from the area to an illuminant, based on the representative projective coordinate system vector and a normal of a model plane of the area, and

a texture drawing apparatus including a changing unit configured to change the texture based on the eyepoint direction and the illuminant direction, and map the changed texture onto the model plane.

In accordance with a fourth aspect of the invention, there is provided a texture mapping method comprising: computing a plurality of projective coordinate system vectors to be acquired when a texture corresponding to an area included in a model surface is projected onto the area, based on configuration information of the area and the texture; computing an eyepoint direction from the area to an eyepoint and an illuminant direction from the area to an illuminant, based on the projective coordinate system vectors and a normal of a model plane of the area; changing the texture based on the eyepoint direction and the illuminant direction; and mapping the changed texture onto the model plane of the area.

In accordance with a fifth aspect of the invention, there is provided a texture mapping program stored in a computer readable medium comprising: means for instructing a computer to compute a plurality of projective coordinate system vectors to be acquired when a texture corresponding to an area included in a model surface is projected onto the area, based on configuration information of the area and the texture; means for instructing the computer to compute an eyepoint direction from the area to an eyepoint and an illuminant direction from the area to an illuminant, based on the projective coordinate system vectors and a normal of a model plane of the area; and means for instructing the computer to change the texture based on the eyepoint direction and the illuminant direction, and map the changed texture onto the model plane of the area.

### BRIEF DESCRIPTION OF THE SEVERAL VIEWS OF THE DRAWING

FIG. 1 is a block diagram illustrating a texture mapping apparatus according to a first embodiment of the invention;

FIG. 2 is a view illustrating spherical coordinates used when texture mapping based on the position of view and the position of an illuminant is performed;

FIG. 3 is a flowchart illustrating the operation of the texture mapping apparatus of FIG. 1;

FIG. 4 is a view useful in explaining a method example for acquiring the vectors U and V of a projective coordinate system;

FIGS. 5A and 5B are views useful in explaining a method example for acquiring a relative position in a direction of longitude;

FIG. 6 is a flowchart illustrating a modification of the procedure of FIG. 3;

FIGS. 7A and 7B are block diagrams illustrating a texture mapping apparatus according to a second embodiment of the invention;

FIGS. 8A and 8B are flowcharts illustrating the operation of the texture mapping apparatus of FIG. 7;

FIG. 9 is a view useful in explaining a method example for computing a representative projective vector;

FIG. 10 is a view useful in explaining an interpolation method example for a representative projective vector;

FIGS. 11A and 11B are block diagrams illustrating a texture mapping apparatus according to a third embodiment of the invention; and

FIGS. 12A and 12B are flowcharts illustrating the operation of the texture mapping apparatus of FIG. 11.

### DETAILED DESCRIPTION OF THE INVENTION

The embodiments of present invention has been developed in light of the above-described problem of the prior art, and aims to provide a texture mapping apparatus capable of representing the anisotropic appearance of a texture material by reducing the seams of texture boundary lines, and a texture mapping method and program that enable such representation.

The texture mapping apparatus, method and program can represent the anisotropic appearance of a texture material by reducing the seams of texture boundary lines.

Referring to the accompanying drawings, a detailed description will be given of texture mapping apparatuses, methods and programs according to embodiments of the invention. After the outline of a texture mapping apparatus is briefly described, each embodiment will be described.

How a three-dimensional substance is viewed, i.e., the configuration of the substance, and the surface color and texture of the substance, varies depending upon the direction (direction of an eyepoint) in which the substance is viewed, and the direction (illuminant direction) in which light is emitted. In the field of three-dimensional computer graphics, the surface of a three-dimensional substance is divided into a large number of unit portions called polygons, and image drawing is performed on each polygon to generate a two-dimensional image that is used as the display image of the three-dimensional substance.

Further, how a three-dimensional substance is viewed when the direction of an eyepoint and/or the direction of an illuminant changes can be represented by varying the posture (three-dimensional orientation) of each displaying polygon and the optical characteristics (e.g., brightness) of each displaying polygon in accordance with changes in the direction of the eyepoint and/or the direction of the illuminant.

Furthermore, to meet a request to represent surface details (such as patterns) of each polygon, a method called texture mapping is employed. Texture mapping is a technique for mapping images (texture images) on a polygon surface.

In texture mapping, high-quality rendering can be realized assigning texture coordinates to the vertices of each polygon to control the mapping portion of the texture image or using real photographic image as a texture image.

### FIRST EMBODIMENT

As shown in FIG. 1, a texture mapping apparatus 100 according to a first embodiment comprises a texture-projective coordinate system computation unit 101, eyepoint/illuminant direction computation unit 102, texture storage unit 103 and drawing unit 104.

The texture-projective coordinate system computation unit 101 receives model-configuration data, and computes the projective coordinate system of each texture corresponding to a model indicated by the data, and the normal of a model plane within each projective coordinate system.

The eyepoint/illuminant direction computation unit 102 receives the vectors of each texture projective coordinate system and the normal of each model plane, which are computed by the texture-projective coordinate system computation unit 101, and computes the relative directions of the eyepoint and illuminant with respect to each model plane.

The texture storage unit 103 stores textures corresponding to the respective eyepoint and illuminant directions.

To draw an image, the drawing unit 104 maps textures, acquired from the texture storage unit 103, based on the eyepoint and illuminant directions computed by the eyepoint/illuminant direction computation unit 102. More specifically, the drawing unit 104 performs mapping by selecting texture images corresponding to the positions of the eyepoint and illuminant, based on the bi-directional texture function (BTF) that represents the texture components of the surface of each polygon.

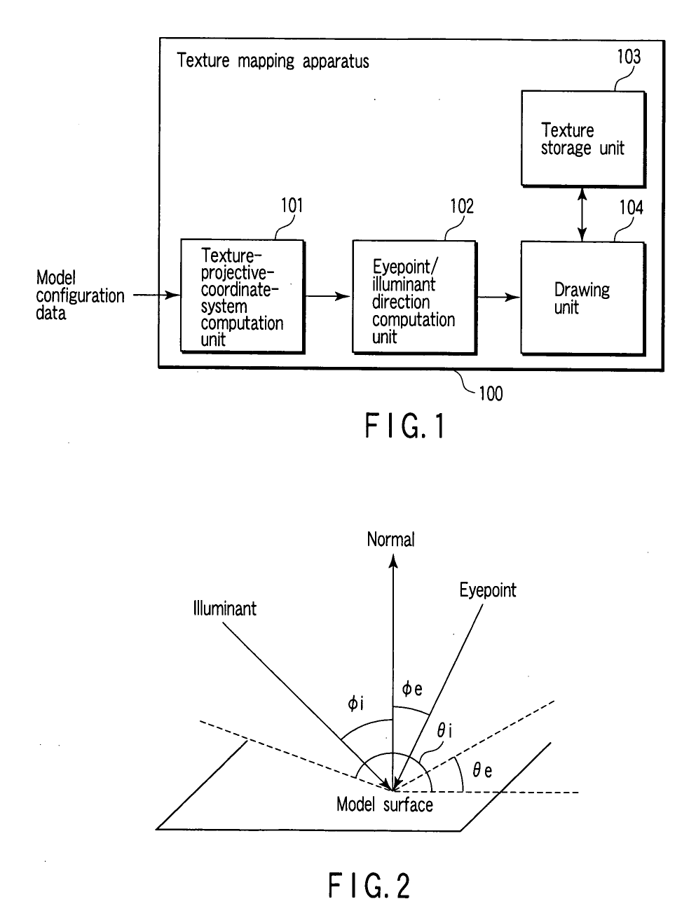

In the BTF, a spherical coordinate system, in which a photography target on the model surface shown in FIG. 2 is regarded as the origin, is used. FIG. 2 shows a spherical coordinate system used when texture mapping based on eyepoint and illuminant positions is performed.

Assuming that the eyepoint is at infinity and the illuminant uses parallel light, the eyepoint position and illuminant position can be represented by (θe, φe) and (θi, φi), respectively, θe and θi being angles in the direction of longitude, φe and φi being angles in the direction of latitude. In this case, each texture address can be defined by six-dimensional data as below. Namely, each texel (texture coordinates) is represented by, for example, six variables, i.e., T (θe, φe, θi, φi, u, v) (u and v indicate addresses in each texture). Actually, a plurality of texture images acquired in particular directions of the eyepoint and particular directions of the illuminant are accumulated, and each texture can be represented by a combination of texture images and addresses in each texture. Texture mapping of this type is called higher-order texture mapping.

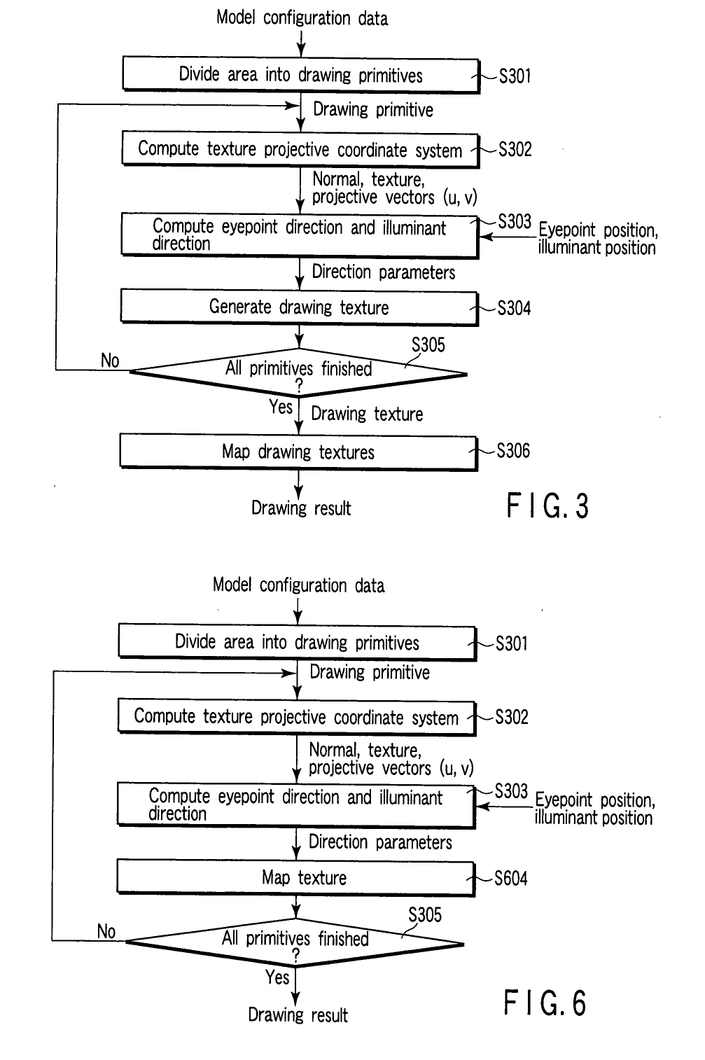

Referring now to FIG. 3, the operation of the texture mapping apparatus of the first embodiment will be described.

Firstly, the texture-projective coordinate system computation unit 101 receives model configuration data, and divides, into drawing primitives, the area indicated by the data (step S301). Namely, this division operation means division of the area into drawing-process units. Basically, the division operation is performed on each polygon formed of three vertices. Each polygon is surface information concerning a surface defined by three vertices. The texture mapping apparatus 100 performs drawing processing in each polygon.

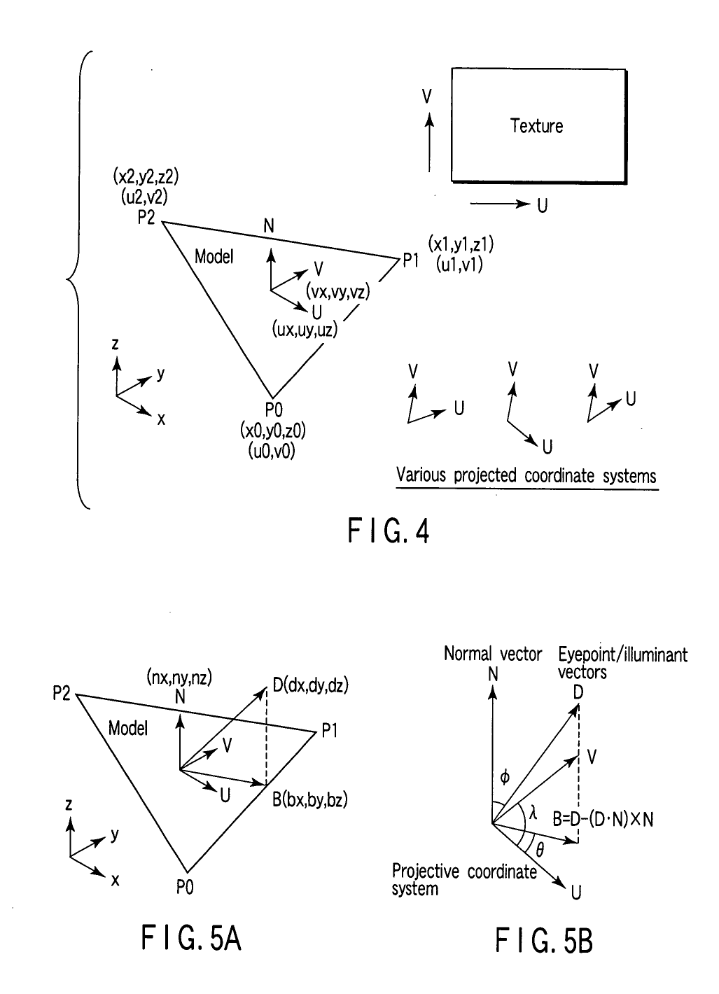

Subsequently, the texture-projective coordinate system computation unit 101 computes a texture projective coordinate system on each drawing primitive (step S302). Specifically, the texture projective coordinate system computation unit 101 computes vectors U and V of the projective coordinate system acquired when the u- and v-axes of the two-dimensional coordinates defining a texture are projected onto the plane formed of three vertices that are represented by three-dimensional coordinates and provide a drawing primitive. Further, the texture-projective coordinate system computation unit 101 computes the normal with respect to the plane formed of the three vertices. The specific method for acquiring vectors U and V of a projective coordinate system will be described later with reference to FIG. 4.

After that, the eyepoint/illuminant direction computation unit 102 receives the vectors U and V, and normal of the projective coordinate system computed at step S302, and receives eyepoint and illuminant positions, thereby acquiring eyepoint and illuminant directions (direction parameters) to detect relative eyepoint and illuminant directions with respect to each drawing primitive (step S303).

More specifically, relative direction φ as a direction of latitude is given by the following equation, based on normal vector N and direction vector D of the projective coordinate system:
φ=arccos(D·N/(|D|×|N|))
where D·N is the inner product of vectors D and N. The method for acquiring relative direction θ as a direction of longitude will be described later with reference to FIGS. 5A and 5B.

Thereafter, the drawing unit 104 generates a drawn texture, based on the relative eyepoint and illuminant directions computed at step S303 (step S304). The generation of the drawn texture is performed to beforehand draw a texture to which drawing primitives are attached. The drawing unit 104 acquires texels (chunk of texture components to be mapped) from textures stored in the texture storage unit 103, based on the relative eyepoint and illuminant directions computed at step S303. The acquired texels are allocated as a texture element within a texture coordinate space corresponding to each drawing primitive. It is sufficient that the acquisition of the relative directions and texture element is performed on each eyepoint or illuminant. Even when a plurality of eyepoints or illuminants exist, the relative directions can be acquired in the same manner as the above.

After the process ranging from step S302 to step S304 is performed concerning all drawing primitives acquired at step S301 (step S305), the program proceeds to step S306.

When drawing of all primitives is finished, the drawing unit 104 maps the drawn textures onto the corresponding portions of the model (step S306).

Referring then to FIG. 4, a description will be given of a specific method for acquiring vectors U and V of the projective coordinate system, employed at step S302 of FIG. 3.

The three-dimensional coordinates and texture coordinates of each of the three vertices providing each drawing primitive are defined as follows:

Vertex P0: Three-dimensional coordinates (x0, y0, z0), Texture coordinates (u0, v0);

Vertex P1: Three-dimensional coordinates (x1, y1, z1), Texture coordinates (u1, v1); and

Vertex P2: Three-dimensional coordinates (x2, y2, z2), Texture coordinates (u2, v2).

In this case, vectors U (ux, uy, uz) and V (vx, vy, vz) of the projective coordinate system, acquired when the u- and v-axes of the two-dimensional coordinates defining a texture are projected onto the plane formed of three vertices that are represented by three-dimensional coordinates and provide a drawing primitive, are given by
P2−P0=(u1−u0)×U+(v1−v0)×V
P1−P0=(u2−u0)×U+(v2−v0)×V

Since P0=(x0, y0, z0), P1=(x1, y1, z1) and P3=(x3, y3, z3), if the above two relational expressions are solved concerning ux, uy, uz, wx, vy and vz, vectors U and V of the projective coordinate system can be acquired. Namely,
ux=idet×(v20×x10−v10×x20)
uy=idet×(v20×y10−v10×y20)
uz=idet×(v20×z10−v10×z20)
vx=idet×(−u20×x10+u10×x20)
vy=idet×(−u20×y10+u10×y20)
vz=idet×(−u20×z10+u10×z20)

However,
v10=v1−v0
v20=v2−v0
x10=x1−x0
x20=x2−x0
y10=y1−y0
y20=y2−y0
z10 =z1−z0
z20=z2−z0
det=u10×v20−u20×v10
idet=1/det

Further, the normal of the drawing primitive corresponding to the above projective coordinate system can be easily acquired by computing, from the coordinates of the three vertices, the outer product of the two independent vectors included in the plane formed of the three vertices of the primitive.

Referring to FIGS. 5A and 5B, a description will be given of a specific method for acquiring relative direction θ as a direction of longitude, employed at step S303 of FIG. 3.

Firstly, vector B is acquired by projecting the eyepoint or illuminant direction vector onto a model plane. Vector B (B=bx, by, bz) is given by
B=D−(D·N)×N
where D (D=dx, dy, dz) is the direction vector D of the eyepoint or illuminant, and N (N=nx, ny, nz) is the normal vector of the model plane.

If this relational expression is expressed using the components of the vectors, the following are acquired:
bx=dx−αnx
by=dy−αny
bz=dz−αnz
where α=dx×nx+dy×ny+dz×nz, and normal vector N is the unit vector.

From vector B acquired by projecting the eyepoint or illuminant direction vector onto the model plane, and vectors U and V of the projective coordinate system acquired at step S302, the relative directions of the eyepoint and illuminant can be computed in the following manner:

Firstly, the angle λ between vectors U and V, and the angle θ between vectors U and B are computed using the following equations:
λ=arccos(U·V/(|U|×|V|))
θ=arccos(U·B/(|U|×|B|))

If the projective coordinate system is not distorted, vectors U and V are orthogonal each other, i.e., λ=π/2 (90°). In contrast, if the projective coordinate system is distorted, λ≠π/2. However, when acquiring a texture, the eyepoint and illuminant directions are represented by relative directions in an orthogonal coordinate system. Therefore, if the projective coordinate system is distorted, it must be corrected. In this case, it is sufficient if the relative angles of the eyepoint and illuminant directions are appropriately corrected in accordance with the projected UV coordinate system. Namely, relative direction θ′ acquired after correction is given by

If θ<π and θ<λ,
θ′=(θ/λ)×π/2

If θ<π and θ>λ,
θ′=π−((π−θ)/(π−λ))×π/2

If θ>π and θ<π+λ,
θ′=(θ−π)/λ×π/2+π

If θ>π and θ>π+λ,
θ′=2π−((2π−θ)/(π−λ))×π/2

By the above-described process, the relative directions of the eyepoint and illuminant as directions of longitude can be acquired for each drawing primitive.

Referring now to FIG. 6, a description will be given of a modification of the operation of the texture mapping apparatus 100 shown in FIG. 3. In FIG. 6, steps similar to those of FIG. 3 are denoted by reference numerals, and no detailed description is given thereof.

Instead of step S304 in FIG. 3, the drawing unit 104 performs texture mapping on each drawing primitive (step S604). This modification process does not require a memory for securing drawing textures unlike the process shown in FIG. 3. Further, since the modification process is performed on each drawing primitive even if model data that uses common texture coordinates occurs, it is preferable for a multiplexing drawing process including a transparent process.

The texture mapping apparatus, method and program according to the above-described embodiment can correct incorrect texture representation that occurs when a texture element, which does not correspond to an acquired texture, is erroneously mapped, and that is regarded as a problem in texture mapping (higher-order texture mapping) depending upon the direction of an illuminant or eyepoint relative to a texture. As a result, the anisotropic appearance of a texture material can be represented appropriately. Further, since the projective coordinates of a texture and the direction of an illuminant, eyepoint, etc. can be calculated on each vertex, the seams that occur at primitive boundaries in the prior art can be reduced, thereby realizing a high-quality drawing process.

### SECOND EMBODIMENT

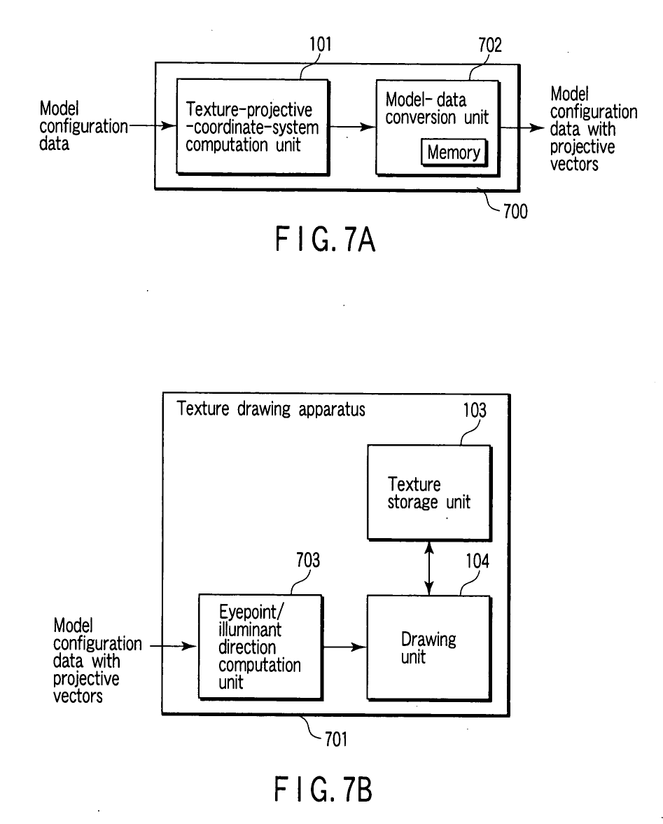

FIGS. 7A and 7B show a texture mapping apparatus according to a second embodiment. As shown, this texture mapping apparatus is acquired by dividing the apparatus of FIG. 1 into two sections. Namely, the texture mapping apparatus of the second embodiment comprises a model-data conversion apparatus 700 and texture drawing apparatus 701. In the second embodiment, elements similar to those of the first embodiment are denoted by corresponding reference numerals, and no description is given thereof.

The model-data conversion apparatus 700 includes a texture-projective coordinate system computation unit 101 and model-data conversion unit 702. The texture drawing unit 701 includes an eyepoint/illuminant direction computation unit 703, texture storage unit 103 and drawing unit 104.

The model-data conversion unit 702 unites texture projective coordinates on each common vertex, converts the united coordinates into new texture projective coordinates, and converts them into model configuration data with projective vectors. The model-data conversion unit 702 has a memory that stores, as vertex information for each vertex of each drawing primitive, vectors U and V of a projective coordinate system, and the normal of a model plane including three vertex and corresponding to each drawing primitive. Thus, the unit 702 stores vertex information corresponding to all model configuration data input by the texture-projective coordinate system computation unit 101.

The eyepoint/illuminant direction computation unit 703 receives each model configuration data item with projective vectors from the model-data conversion unit 702, and computes the directions of the eyepoint and illuminant relative to each model plane, based on the vectors of a texture projective coordinate system on each vertex, and the normal of each model plane.

The model-data conversion apparatus 700 and texture drawing apparatus 701 may be installed in a single machine or in separate machines connected to each other via a network. In the case where they are connected via the network, model configuration data with projective vectors is transmitted from the model-data conversion apparatus 700 to the texture drawing apparatus 701 via the network.

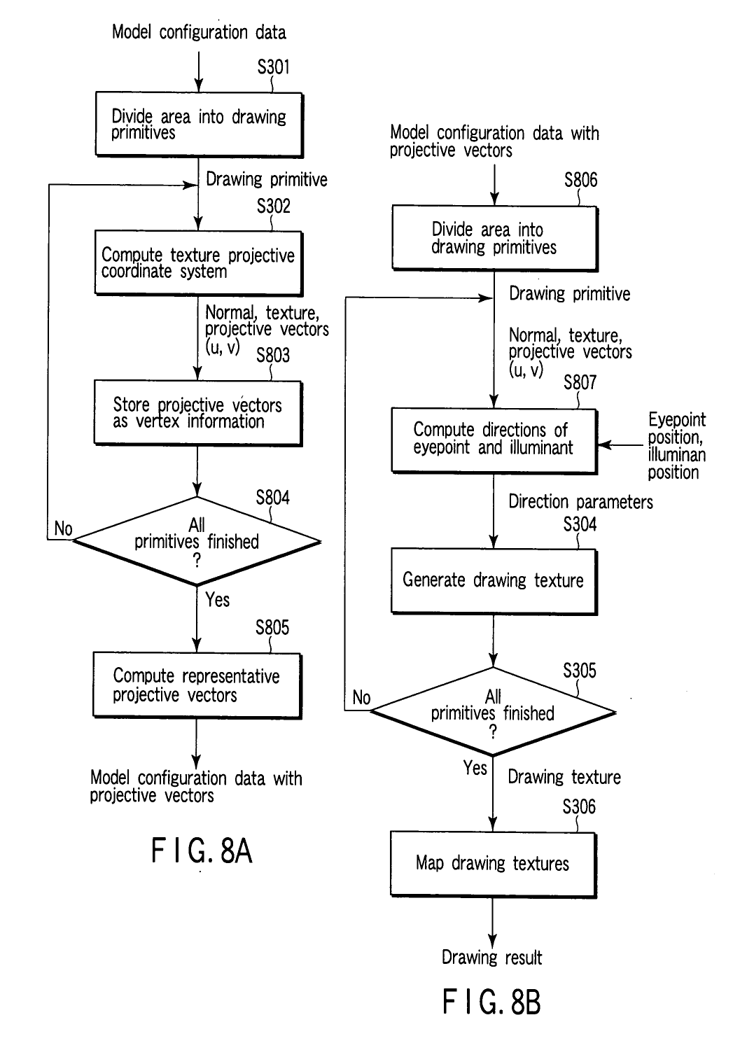

Referring to FIGS. 8A and 8B, a description will be given of the operations of the model-data conversion apparatus 700 and texture drawing apparatus 701. Steps similar to those of FIG. 3 are denoted by corresponding reference numerals, and are not described.

At step S803, the model-data conversion unit 702 receives vectors U and V of each projective coordinate system, and the normal of each model plane including three vertices, which are acquired from each drawing primitive by texture projective coordinate system computation. The unit 702 stores the vectors U and V and the normal as vertex information. The unit 702 sequentially stores vectors U and V acquired at step S302 for each vertex included in each drawing primitive. If index information for identifying each vertex exists, vertex data liked to each same index may be generated.

At step S804, the processes at steps S302 and S803 are repeated on all drawing primitives acquired at step S301. After that, the program proceeds to step S805.

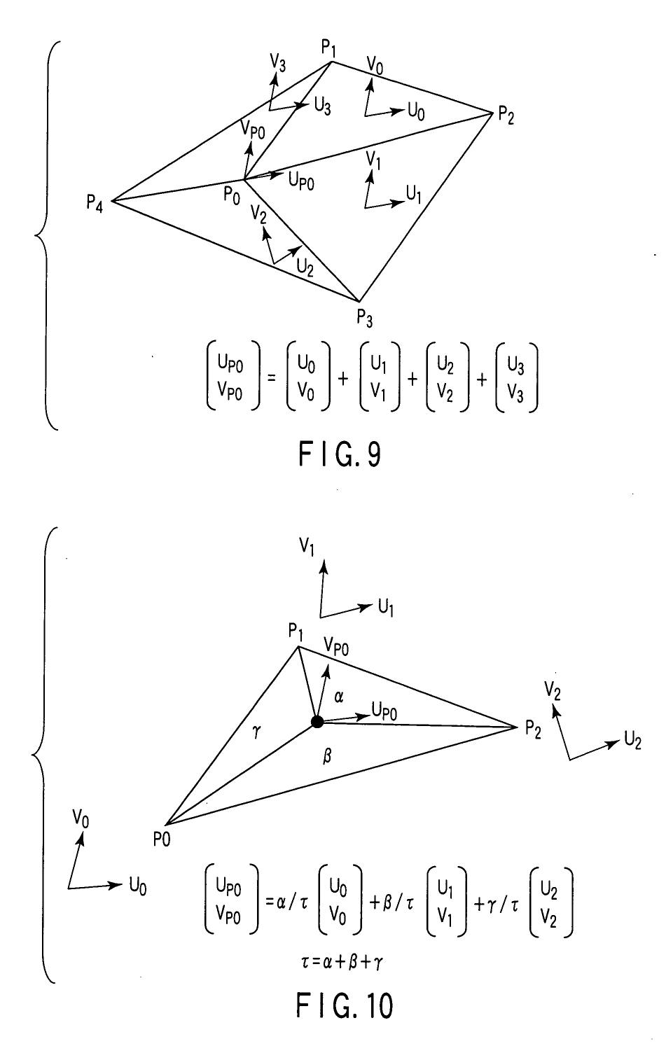

Based on the vertex information acquired at step S803, the model-data conversion unit 702 computes a projective vector (also called a representative projective vector) of each vertex (step S805). A method for acquiring the representative projective vector will be described later with reference to FIG. 9.

At the next step and later ones, the texture drawing apparatus 701 performs processing.

The eyepoint/illuminant direction computation unit 703 receives the model configuration data with the representing projective vectors, and again divides, into drawing primitives, the area indicated by the data (step S806). This division may be similar to that performed at step S301, or may be performed by changing the combinations of vertices included in drawing primitives.

The eyepoint/illuminant direction computation unit 703 receives a normal and projective vectors U and V corresponding to each drawing primitive acquired by the division, and receives the positions of an eyepoint and illuminant. Based on the received data, the unit 703 computes direction parameters indicating the directions of the eyepoint and illuminant, and acquires the relative directions of the eyepoint and illuminant with respect to each drawing primitive (step S807). The method for determining the relative directions at step S807 is similar to that employed at step S303, except that in the former, the vectors of projective coordinate systems included in each drawing primitive are not always identical between the vertices of each drawing primitive. Therefore, it is necessary to compute the vectors of a projective coordinate system, which corresponds to the texture coordinates of each vertex included in each drawing primitive, by interpolation of projective coordinate vectors representing the three vertices of each drawing primitive. The representative projective vector interpolation method will be described later with reference to FIG. 10.

The next step and later ones are similar to those of the first embodiment shown in FIG. 3.

A method example for acquiring a representative projective vector will be described with reference to FIG. 9.

If a plurality of vertices are used in common between drawing primitives, a single representative projective vector U and a single representative projective vector V are computed for each vertex by performing a kind of averaging the vectors U and V of projective coordinate systems corresponding to the drawing primitives. Specifically, if drawing primitives are arranged as shown in FIG. 9, the representative projective vector of each vertex is computed using the following equation:
(U_{P0},V_{PO})=(U₀,V_{O})+(U₁,V₁)+(U₂,V₂)+(U₃,V₃)
where (U_{P0}, V_{PO}) is a combination of representative projective vectors, and (U₀, V_{O}), (U₁, V₁), (U₂, V₂) and (U₃, V₃) are combinations of the vectors of the projective coordinate systems of drawing primitives provided around the vertex to which the representative projective vectors are assigned.

A method example for interpolating a representative projective vector will be described with reference to FIG. 10.

In a method for interpolating each representative projective vector in a model plane, a texture area is divided into three sections using the derived texture coordinates of each vertex, and the interpolation coefficient is varied between the three sections. Specifically, (U_{P0}, V_{PO}) can be interpolated using the following equations:
(U_{P0},V_{PO})=α/τ(U₀,V_{O})+β/τ(U₁,V₁)+γ/τ(U₂,V₂)
τ=α+β+γ
where (U_{P0}, V_{PO}) is the combination of the vectors of a projective coordinate system in the derived texture coordinates, (U₀, V_{O}), (U₁, V₁) and (U₂, V₂) are combinations of representative projective vectors corresponding to the vertices that define the derived texture coordinates, and α, β and γ are the three sections defined by connecting the origin of the vertex's texture coordinates to each of the vertices, as is shown in FIG. 10.

In the above-described texture mapping apparatus, method and program of the second embodiment, vector information indicating projective coordinate systems of a texture can be output as unified attributes of vertices for correcting distortion that occurs when higher-order texture mapping is performed. Further, if this information is received, distortion-corrected higher-order texture mapping can be realized, which enables the anisotropic appearance of a texture material to be appropriately represented. Moreover, since the projective coordinate system of a texture and the directions of an illuminant, eyepoint, etc. can be output as unified attributes of vertices, the seams that occur at primitive boundaries in the prior art can be reduced, thereby realizing a high-quality drawing process.

In the present invention, vectors U and V indicating each projective coordinate system in a texture are added as the vector information in addition to the normal vectors in the prior art. This enables higher-quality image generation in efficient manner by utilizing a hardware-based graphics acceleration framework such as vertex shader on commodity GPU (Graphical Processing Unit).

In the second embodiment, a drawing texture is generated before mapping is performed. Drawing processing without generating the drawing texture may be performed on each drawing primitive, as in the modification of the first embodiment shown in FIG. 6.

### THIRD EMBODIMENT

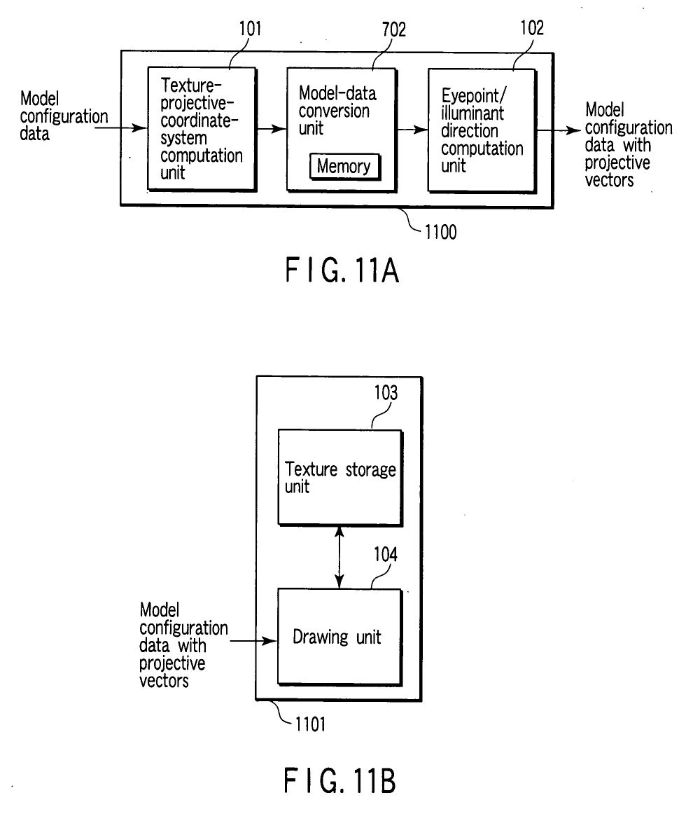

FIGS. 11A and 11B show a texture mapping apparatus according to a third embodiment. As shown, this texture mapping apparatus is acquired by dividing the apparatus of FIG. 1 into two sections. Namely, the texture mapping apparatus of the third embodiment comprises a model-data conversion apparatus 1100 and texture drawing apparatus 1101. In the third embodiment, elements similar to those of the first and second embodiments are denoted by corresponding reference numerals, and no description is given thereof.

The model-data conversion apparatus 1100 includes a texture-projective coordinate system computation unit 101, model-data conversion unit 702 and eyepoint/illuminant direction computation unit 102. The texture drawing unit 1101 includes a texture storage unit 103 and drawing unit 104.

The model-data conversion apparatus 1100 receives model configuration data and outputs model configuration data with direction parameters. The texture drawing unit 1101 receives the model configuration data with direction parameters, and maps drawn textures onto appropriate portions of the model.

As in the second embodiment, the model-data conversion apparatus 1100 and texture drawing apparatus 1101 may be installed in a single machine or in separate machines connected to each other via a network. In the case where they are connected via the network, model configuration data with projective vectors is transmitted from the model-data conversion apparatus 1100 to the texture drawing apparatus 1101 via the network.

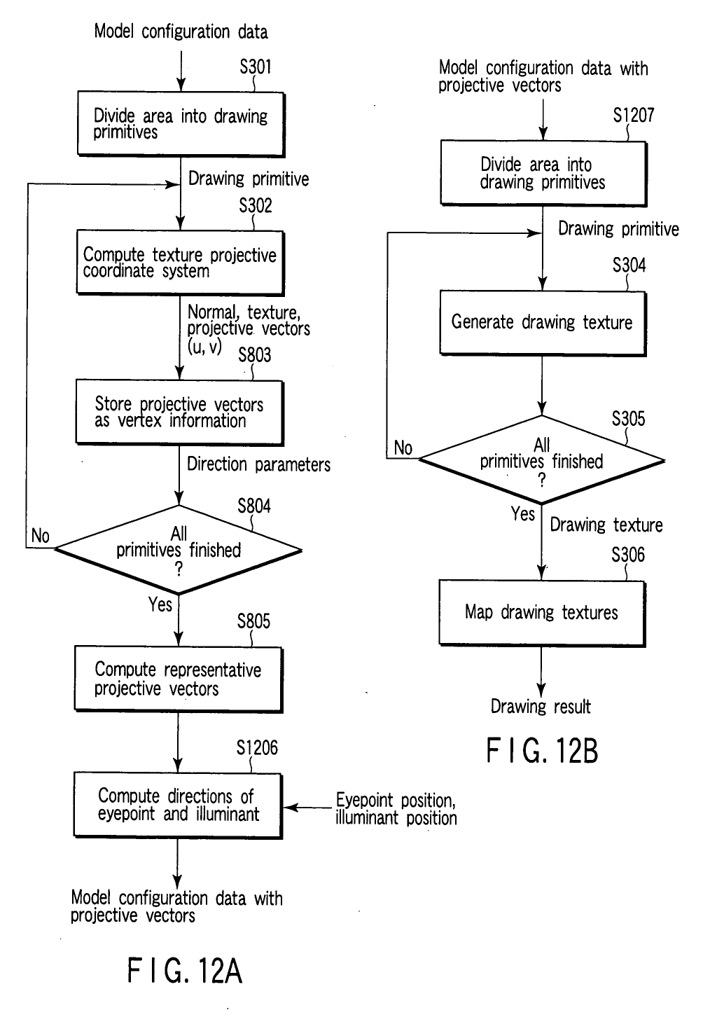

Referring to FIGS. 12A and 12B, a description will be given of the operations of the model-data conversion apparatus 1100 and texture drawing apparatus 1101. Steps similar to those of FIG. 3 (first embodiment) and FIGS. 8A and 8B (second embodiment) are denoted by corresponding reference numerals, and are not described.

At step S1206, the eyepoint/illuminant direction computation unit 102 receives a normal and projective vectors U and V corresponding to each drawing primitive, and receives the positions of an eyepoint and illuminant. Based on the received data, the unit 102 computes direction parameters indicating the directions of the eyepoint and illuminant, acquires the relative directions of the eyepoint and illuminant with respect to each drawing primitive, and outputs model configuration data with direction parameters indicating the relative directions. The texture-projective coordinate system computation unit 101 acquires a three-dimensional normal vector concerning the surface of the model by, for example, computing the outer product of the vectors included in each drawing primitive, based on the relationship between the vertices of each primitive. If the model data contains a normal vector corresponding to each vertex, this normal vector may be utilized.

Each direction parameter can be represented from the relationship between the sight-line vector connecting a vertex of a drawing primitive to the eyepoint position, an illuminant vector connecting the vertex to the illuminant position, and a normal vector corresponding to the drawing primitive. The relative direction of the eyepoint vector with respect to the normal vector, which is used as an eyepoint direction parameter, can be represented by polar coordinates (θe, φe). Similarly, the relative direction of the illuminant vector with respect to the normal vector, which is used as an illuminant direction parameter, can be represented by polar coordinates (θi, φi). Model configuration data with direction parameters can be finally taken out of the eyepoint/illuminant direction computation unit 102 of the model-data conversion apparatus 1100.

The data amount of each direction parameter is smaller than that of a projective vector output from the model-data conversion apparatus 700 of the second embodiment. Therefore, if the model-data conversion apparatus 1100 and texture drawing apparatus 1101 are connected via a network, the texture mapping apparatus of the third embodiment is more suitable for data transmission than the other texture mapping apparatuses.

The next step and later ones are performed by the texture drawing apparatus 1101.

The drawing unit 104 receives model configuration data with representative direction parameters, and again divides, into drawing primitives, the area indicated by the data (step S806). This division may be similar to that performed at step S301, or may be performed by changing the combinations of vertices included in drawing primitives.

In the above-described texture mapping apparatus, method and program of the third embodiment, information indicating the eyepoint direction and/or illuminant direction can be output as vector units of vertices for correcting distortion that occurs when higher-order texture mapping is performed. Further, if this information is received, distortion-corrected higher-order texture mapping can be realized, which enables the anisotropic appearance of a texture material to be appropriately represented. Moreover, since the projective coordinate system of a texture and the directions of an illuminant, eyepoint, etc. can be output as vector units of vertices, the seams that occur at primitive boundaries in the prior art can be reduced, thereby realizing a high-quality drawing process.

Since the direction information acquired as vector units of vertices, processing vector interpolation can be efficiently realized utilizing a hardware framework that supports vector processing graphics hardware such as vertex shader on commodity GPU (Graphics Processing Unit).

In the third embodiment, a drawing texture is generated and mapping is performed. However, drawing texture may not be generated and drawing processing may be performed on each drawing primitive, as in the modification of the first embodiment shown in FIG. 6.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block of blocks. The computer program instructions may also be loaded onto a computer or other programmable apparatus to cause a series of operational steps to be performed on the computer or other programmable apparatus to produce a computer programmable apparatus provide steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A texture mapping apparatus comprising:
a vector computation unit configured to compute a plurality of projective coordinate system vectors to be acquired when a texture corresponding to an area included in a model surface is projected onto the area, based on configuration information of the area and the texture;
a direction computation unit configured to compute an eyepoint direction from the area to an eyepoint and an illuminant direction from the area to an illuminant, based on the projective coordinate system vectors and a normal of a model plane of the area; and
a changing unit configured to change the texture based on the eyepoint direction and the illuminant direction, and map the changed texture onto the model plane of the area.

2. The apparatus according to claim 1, wherein the vector computation unit computes the projective coordinate system vectors based on a plurality of three-dimensional coordinates of the model surface and a plurality of texture coordinates of the model surface.

3. The apparatus according to claim 1, wherein the direction computation unit computes, utilizing polar coordinates, the eyepoint direction and the illuminant direction with respect to the area, based on the projective coordinate system vectors and the normal of the model plane.

4. The apparatus according to claim 1, further comprising a storage unit configured to store a plurality of textures, and
wherein the changing unit includes:
a read unit configured to read, from the storage unit, a texture corresponding to the eyepoint direction and the illuminant direction; and
a mapping unit configured to map the read texture onto the model plane of the area.

5. The apparatus according to claim 4, wherein the textures stored in the storage unit correspond to a plurality of various eyepoint directions from the area to a plurality of eyepoints and a plurality of various illuminant directions from the area to a plurality of illuminants.

6. A texture mapping apparatus comprising:
a model-data conversion apparatus including:
a vector computation unit configured to compute a plurality of projective coordinate system vectors to be acquired when a texture corresponding to an area included in a model surface is projected onto the area, based on configuration information of the area and the texture; and
a representative vector computation unit configured to compute a representative projective coordinate system vector which represents a plurality of areas included in the model surface, based on the projective coordinate system vectors, and
a texture drawing apparatus including:
a direction computation unit configured to compute an eyepoint direction from the area to an eyepoint and an illuminant direction from the area to an illuminant, based on the representative projective coordinate system vector and a normal of a model plane of the area;
a changing unit configured to change the texture based on the eyepoint direction and the illuminant direction, and map the changed texture onto the model plane.

7. The apparatus according to claim 6, wherein the vector computation unit computes the projective coordinate system vectors based on a plurality of three-dimensional coordinates of the model surface and a plurality of texture coordinates of the model surface.

8. The apparatus according to claim 6, wherein the direction computation unit computes, utilizing polar coordinates, the eyepoint direction and the illuminant direction with respect to the area, based on the projective coordinate system vectors and the normal of the model plane.

9. The apparatus according to claim 6, further comprising a storage unit configured to store a plurality of textures, and
wherein the changing unit includes:
a read unit configured to read, from the storage unit, a texture corresponding to the eyepoint direction and the illuminant direction; and
a mapping unit configured to map the read texture onto the model plane of the area.

10. The apparatus according to claim 9, wherein the textures stored in the storage unit correspond to a plurality of various eyepoint directions from the area to a plurality of eyepoints and a plurality of various illuminant directions from the area to a plurality of illuminants.

11. A texture mapping apparatus comprising:
a model-data conversion apparatus including:
a vector computation unit configured to compute a plurality of projective coordinate system vectors to be acquired when a texture corresponding to an area included in a model surface is projected onto the area, based on configuration information of the area and the texture;
a representative vector computation unit configured to compute a representative projective coordinate system vector which represents a plurality of areas included in the model surface, based on the projective coordinate system vectors; and
a direction computation unit configured to compute an eyepoint direction from the area to an eyepoint and an illuminant direction from the area to an illuminant, based on the representative projective coordinate system vector and a normal of a model plane of the area, and
a texture drawing apparatus including a changing unit configured to change the texture based on the eyepoint direction and the illuminant direction, and map the changed texture onto the model plane.

12. The apparatus according to claim 11, wherein the vector computation unit computes the projective coordinate system vectors based on a plurality of three-dimensional coordinates of the model surface and a plurality of texture coordinates of the model surface.

13. The apparatus according to claim 11, wherein the direction computation unit computes, utilizing polar coordinates, the eyepoint direction and the illuminant direction with respect to the area, based on the projective coordinate system vectors and the normal of the model plane.

14. The apparatus according to claim 11, further comprising a storage unit configured to store a plurality of textures, and
wherein the changing unit includes:
a read unit configured to read, from the storage unit, a texture corresponding to the eyepoint direction and the illuminant direction; and
a mapping unit configured to map the read texture onto the model plane of the area.

15. The apparatus according to claim 14, wherein the textures stored in the storage unit correspond to a plurality of various eyepoint directions from the each area to a plurality of eyepoints and a plurality of various illuminant directions from the area to a plurality of illuminants.

16. A texture mapping method comprising:
computing a plurality of projective coordinate system vectors to be acquired when a texture corresponding to an area included in a model surface is projected onto the area, based on configuration information of the area and the texture;
computing an eyepoint direction from the area to an eyepoint and an illuminant direction from the area to an illuminant, based on the projective coordinate system vectors and a normal of a model plane of the area;
changing the texture based on the eyepoint direction and the illuminant direction; and
mapping the changed texture onto the model plane of the area.

17. A texture mapping program stored in a computer readable medium comprising:
means for instructing a computer to compute a plurality of projective coordinate system vectors to be acquired when a texture corresponding to an area included in a model surface is projected onto the area, based on configuration information of the area and the texture;
means for instructing the computer to compute an eyepoint direction from the area to an eyepoint and an illuminant direction from the area to an illuminant, based on the projective coordinate system vectors and a normal of a model plane of the area; and
means for instructing the computer to change the texture based on the eyepoint direction and the illuminant direction, and map the changed texture onto the model plane of the area.
